(19) United States
(12) Patent Application Publication
(10) Pub. No.: US 2018/0002538 A1
(43) Pub. Date: Jan. 4, 2018

(54) COMPOSITIONS AND METHODS FOR PROVIDING HIGH WHITENESS AND/OR BRIGHTNESS

(71) Applicant: Imerys USA, Inc., Roswell, GA (US)

(72) Inventors: Parvin GOLBAYANI, Kennesaw, GA (US); Mathew CHEESEMAN, Camborne, Cornwall (GB); Christopher PAYNTER, Atlanta, GA (US); Douglas WICKS, Johns Creek, GA (US)

(21) Appl. No.: 15/541,142

(22) PCT Filed: Dec. 30, 2015
(86) PCT No.: PCT/US15/68105

§ 371 Date: Jun. 30, 2017

Related U.S. Application Data
(60) Provisional application No. 62/099,408, filed on Jan. 2, 2015.

(51) Int. Cl. C09D 5/22; C09K 11/66; C09K 11/65; C09K 11/60; C09K 11/55; C09K 11/77; C09D 11/03

(52) U.S. Cl. CPC C09D 5/22; C09K 11/77; C09K 11/66; C09D 11/03; C09K 11/60; C09K 11/55; C09K 11/65

(57) ABSTRACT

A composition may include a base or matrix material, such as a resin, and a first optical brightener. The first optical brightener may include an alkaline earth metal compound and a fluorescence activator. The composition may include less than or equal to about 1.5 wt % of a second optical brightener relative to the weight of the composition, wherein the second optical brightener does not include the fluorescence activator. A composition may include an aqueous base and an optical brightener. The optical brightener may include an alkaline earth metal carbonate and a fluorescence activator, wherein the optical brightener is configured to emit fluorescent light. A composition may include a first optical brightener. The first optical brightener may include an alkaline earth compound, such as an alkaline earth metal salt, and a fluorescence activator, wherein, for a given brightness of a product including the composition, the composition including the first optical brightener may include less of a second optical brightener different from the first optical brightener.

### CLAIM FOR PRIORITY

This PCT International Application claims the benefit of priority of U.S. Provisional Patent Application No. 62/099,408, filed Jan. 2, 2015, the subject matter of which is incorporated herein by reference in its entirety.

### DESCRIPTION

### Field

The present disclosure relates to compositions and related methods for providing high whiteness and/or brightness, and more particularly, to compositions and related methods for providing high whiteness and/or brightness in paper and/or paperboard products including coating compositions, paper making compositions, and/or sizing compositions.

### Background

Coating compositions, paper making compositions, and/or sizing compositions, such as, for example, paints (oil- and water-based paints), sealants, paper coatings, architectural coatings, and industrial coatings (e.g., coatings other than paper coatings), may be used to improve the visual characteristics of a substrate and/or protect a substrate such as paper products including paper and paperboard. Traditional optical brighteners (e.g., organic brightening agents) may be used to improve the perceived whiteness and/or brightness of paper. However, traditional optical brighteners suffer from a number of possible drawbacks. For example, traditional optical brighteners tend to be relatively expensive, rely on inclusion of toxic components (e.g., water-soluble aromatics), suffer from photo-bleaching upon repeated irradiation resulting in loss of effectiveness over time, and are suspected of being allergens, teratogens, and/or endocrine disruptors. Thus, although traditional optical brighteners may be desirable for improving the perceived whiteness and/or brightness of paper, it may be desirable to provide compositions that result in a reduction or elimination of the presence of traditional optical brighteners, but that still provide improvements in perceived whiteness and/or brightness of products without one or more of the above-noted drawbacks of traditional optical brighteners.

### SUMMARY

According to one aspect, a composition may include a base material or matrix material, such as a resin, and an optical brightener including an alkaline earth metal compound, such as an alkaline earth metal salt, with a fluorescence activator. The composition may be configured as at least one of a coating composition, a paper making composition, an ink composition, and a sizing composition.

According to some aspects, the fluorescence activator may include at least one mixture, compound, element or alloy of manganese, molybdenum, copper, uranium, cesium, thorium, lead, cobalt, iron, strontium, calcium, magnesium, barium, tin, yttrium, thallium, thulium, cerium, samarium, cerium, thulium, and dysprosium. According to some aspects, the alkaline earth compound may have a crystal structure, and the fluorescence activator may be contained in the crystal structure.

According to still a further aspect, the alkaline earth compound may comprise an alkaline earth metal carbonate. For example, the alkaline earth metal carbonate may include at least one of calcium carbonate, barium carbonate, magnesium carbonate, and mixtures thereof. For example, the alkaline earth metal carbonate may include precipitated calcium carbonate, precipitated magnesium carbonate, co-precipitated calcium and magnesium carbonates, and mixtures thereof.

While these activators are generally used in the disclosed composition in carbonate forms, others forms are also possible, such as sulfates (SO₄), phosphates (PO₄³⁻), tungstates (WO₄) and fluorides (F⁻).

According to another aspect, the composition may be configured as at least one of a coating composition, a paper making composition, and a sizing composition.

According to yet another aspect, a method for reducing traditional optical brighteners in a composition may include adding to the composition a first optical brightener. The first optical brightener may include at least one alkaline earth metal compound with a fluorescence activator. The method may further include adding to the composition a second optical brightener, wherein the second optical brightener does not include the fluorescence activator. For example, the fluorescence activator may include least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium. According to a further aspect, the second optical brightener may include at least one of sulfonated triazole stilbenes, di-sulfonated stilbene biphenyl, coumarins, imidazolines, diazoles, triazoles, benzoxazolines, and biphenyl-stilbenes.

Exemplary objects and advantages will be set forth in part in the description which follows, or may be learned by practice of the exemplary embodiments. It is to be understood that both the foregoing general description and the following detailed description are exemplary and explanatory only and are not restrictive of the invention, as claimed.

### DESCRIPTION OF EXEMPLARY EMBODIMENTS

As used herein, the term “fluorescence”, or “fluoresce”, or “fluorescent response” refers to the emission of electromagnetic energy (e.g., light) by a substance that has absorbed light or other electromagnetic energy or radiation. The emitted light has a longer wavelength, and therefore lower energy, than the absorbed radiation. However, it is meant to generally encompass irradiation at one wavelength and emission of light at a different wavelength. Examples of fluorescence that can be achieved according to the present disclosure include UV to Visible (the material emits visible light after being irradiated with UV light); UV to UV (wherein the emitted and irradiated wavelengths are different); UV to Near IR; and Visible to Near IR.

As used herein the term “UV” or “ultraviolet” light refers to Near UVA (300 nm to 400 nm); UVB (280 nm to 300 nm); and UVA (100 nm to 280 nm).

As used herein, “dopant” refers to a small amount of an impurity that is an intentionally added to another material, such as an impurity intentionally added to a carbonate matrix.

As used herein, a “doped” material refers to a material in which a dopant was intentionally introduced during production. For example, a “doped carbonate” refers to a carbonate, such as CaCO₃, MgCO₃, BaCO₃, or mixtures thereof, in which a small impurity was intentionally added to change or induce fluorescent response when the carbonate was made.

Compositions and methods according to exemplary aspects of this disclosure may permit the reduction or elimination of traditional optical brighteners from compositions included in paper products, such as, for example, paper and/or paperboard, while substantially maintaining or exceeding the perceived whiteness and/or brightness of the products achievable with traditional optical brighteners.

According to some embodiments, a composition may include an aqueous base material or matrix material, such as a resin. In various aspects, the base material may comprise a fusible powder, an aqueous composition, or a solvent composition (e.g., organic solvent composition), and an optical brightener including an alkaline earth metal compound doped with a fluorescence activator. The at least one optical brightener may include an alkaline earth compound, such as an alkaline earth salt, and a fluorescence activator. The composition may be configured as at least one of a coating composition, a paper making composition, and a sizing composition.

According to some embodiments, the fluorescence activator may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium. According to some embodiments, the alkaline earth metal compound may have a crystal structure, and the fluorescence activator may be contained in the crystal structure.

According to some embodiments, the alkaline earth metal compound may be an alkaline earth metal carbonate. For example, the alkaline earth metal may include at least one of calcium carbonate, barium carbonate, and magnesium carbonate. For example, the alkaline earth metal compound may include precipitated calcium carbonate, precipitated magnesium carbonate, co-precipitated calcium and magnesium carbonates, and mixtures thereof.

While these activators are generally used in the disclosed composition in carbonate forms, others forms are also possible, such as sulfates (SO₄), phosphates (PO₄³⁻), tungstates (WO₄) and fluorides (F⁻).

According to other embodiments, the alkaline earth metal compound may comprise a natural ground calcium carbonate coated with a alkaline earth metal compound doped with a fluorescence activator.

According to some embodiments, the optical brightener may comprise greater than or equal to about 1.0 wt % of the composition. For example, the optical brightener may comprise greater than or equal to about 1.5 wt % of the composition. According to some embodiments, the optical brightener may be configured to emit fluorescent light, for example, when exposed to ultraviolet light.

For example, according to some embodiments, the optical brightener may be configured to emit energy above, for example, about 350 nanometers in response to radiating the optical brightener with, for example, ultraviolet light below about 450 nanometers. According to some embodiments, the optical brightener may be configured to emit energy above, for example, about 400 nanometers in response to radiating the optical brightener with, for example, ultraviolet light below about 400 nanometers.

Without wishing to be bound by theory, it is believed that an optical brightener including an alkaline earth metal compound with the fluorescence activator according to at least some embodiments may increase the perceived whiteness and/or brightness of a product including the optical brightener. In some embodiments, the optical brightener may result in emission of fluorescent light, thereby increasing the perceived whiteness and/or brightness. Thus, the optical brighteners according to at least some embodiments may permit a reduction or elimination of traditional optical brighteners (e.g., organic brightening agents), while substantially maintaining or increasing the perceived whiteness and/or brightness of the products.

For example, the optical brighteners according to at least some embodiments may be configured to excite traditional optical brighteners. Without wishing to be bound by theory, it is believed that traditional optical brighteners absorb energy ranging from about 300 nanometers to about 400 nanometers, with a significant portion (e.g., a majority) of that emission ranging from about 350 nanometers to about 390 nanometers. Optical brighteners according to at least some embodiments disclosed herein (e.g., some precipitated calcium carbonate) may absorb ultraviolet light ranging from about 250 nanometers to about 300 nanometers, and re-emit energy ranging from about 350 nanometers to about 400 nanometers, which may, in turn, boost the performance of traditional optical brighteners. Such brightness may be tested with, for example, a traditional ultraviolet brightness tester and/or a Spectrofluorometer.

According to some embodiments, the composition may be configured as a product (e.g., a paper product) that includes the composition. According to some embodiments, the product including the composition may have a brightness ranging from about 80 to about 100. For example, the product including the composition may have a brightness ranging from about 90 to about 100.

“Brightness,” as expressed herein, is defined in TAPPI Standard T452 and refers to the percentage reflectance to light of a 457 nm wavelength according to methods well known to those of ordinary skill in the art.

Compositions according to some embodiments may be assessed by color with Hunter L* a* b′ coordinates. For example, components “L,” “a,” and “b” are color component values of a 3-dimensional color space scale, which may be measured by, for example, a Hunter Ultrascan XE instrument. On the color space scale, “L” is a measure of whiteness, “+a” is a measure of redness, “−a” is a measure of greenness, “+b” is a measure of yellowness, “−b” is a measure of blueness. Whiteness may be measured according to the ASTM-E-313 standard method. It is to be appreciated that the relative color can be “lighter” (e.g., appearing less blue) or “darker” (e.g., appearing more blue). In the case of tint strength, “lighter” color (i.e., pigment having a higher L value) is considered to have the higher tint strength after addition of a darker color.

According to some embodiments, a composition may include an aqueous base and a first optical brightener. The first optical brightener may include an alkaline earth metal compound and a fluorescence activator, and the composition may include less than or equal to about 1.5 wt % of a second optical brightener (e.g., a traditional optical brightener, for example, an organic brightening agent) relative to the weight of the composition. For example, the second optical brightener may not include a fluorescence activator. According to some embodiments, the composition may not include any of the second optical brightener. According to some embodiments, the fluorescence activator may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium. According to some embodiments, the alkaline earth metal may have a crystal structure, and the fluorescence activator may be contained in the crystal structure.

According to some embodiments, the composition may include less than or equal to about 10.0 wt % of the second optical brightener relative to the weight of the composition, such as less than 5.0 wt %, less than 1.5 wt %, less than 1.0 wt %, or less than or equal to about 0.5 wt % the second optical brightener relative to the weight of the composition.

According to some embodiments, the second optical brightener may be a traditional optical brightener. For example, the second optical brightener may be a traditional optical brightener and may include at least one organic brightening agent such as, for example, at least one of sulfonated triazole stilbenes, di-sulfonated stilbene biphenyl, coumarins, imidazolines, diazoles, triazoles, benzoxazolines, and biphenyl-stilbenes.

According to some embodiments, the alkaline earth metal compound may be an alkaline earth metal carbonate. For example, the alkaline earth metal carbonate may include at least one of calcium carbonate, barium carbonate, and magnesium carbonate. According to some embodiments, the alkaline earth metal carbonate may include precipitated calcium carbonate, precipitated magnesium carbonate, co-precipitated calcium and magnesium carbonates, and mixtures thereof.

According to some embodiments, the first optical brightener may comprise up to 10% of the fluorescence activator, such as less than 5% of the fluorescence activator, or even less than 1% of the fluorescence activator. According to some embodiments, these values are noted for inorganic fluorescence activators that comprise CaCO₃ or MgCO₃. According to some embodiments, the first optical brightener may be configured to emit fluorescent light, for example, when exposed to ultraviolet light.

According to some embodiments, a composition may be configured as at least one of a coating composition, a paper making composition, an ink composition, and a sizing composition. For example, a product (e.g., a paper product) may include the composition. According to some embodiments, the product including the composition may have a brightness ranging from about 80 to about 100. For example, the product including the composition may have a brightness ranging from about 90 to about 100.

According to some embodiments, a composition may include an aqueous base and an optical brightener including an alkaline earth metal compound doped with a fluorescence activator, wherein the optical brightener is configured to emit fluorescent light, for example, in the presence of ultraviolet light. For example, the fluorescence activator may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium. According to some embodiments, the second optical brightener may be a traditional optical brightener (e.g., an organic brightening agent), which may include at least one of sulfonated triazole stilbenes, di-sulfonated stilbene biphenyl, coumarins, imidazolines, d azoles, triazoles, benzoxazolines, and biphenyl-stilbenes. According to some embodiments, the composition may be configured as at least one of a coating composition, a paper making composition, and a sizing composition.

According to some embodiments, the base may include one or more of the following additives, depending on the product in which the composition is included, for example, a coating composition such as paint:
(a) cross linkers, for example, in levels up to 5% by weight (e.g., glyoxals, melamine formaldehyde resins, ammonium zirconium carbonates);
(b) water retention aids, for example, in levels up to 2% by weight (e.g., sodium carboxymethyl cellulose, hydroxyethyl cellulose, PVA (polyvinyl acetate), starches, proteins, polyacrylates, gums, alginates, polyacrylamide bentonite, and other commercially available products sold for such applications);
(c) viscosity modifiers or other thickeners, for example, in levels up to 2% by weight (e.g., polyacrylates, emulsion copolymers, dicyanamide, triols, polyoxyethylene ether, urea, sulphated castor oil, polyvinyl pyrrolidone, montmorillonite, sodium alginate, xanthan gum, sodium silicate, acrylic acid copolymers, HMC (hydroxymethyl celluloses), HEC (hydroxyethyl celluloses));
(d) lubricity/calendaring aids, for example, in levels up to 2% by weight (e.g., calcium stearate, ammonium stearate, zinc stearate, wax emulsions, waxes, alkyl ketene dimer, glycols);
(e) dispersants, for example, in levels up to 2% by weight (e.g., polyelectrolytes, such as polyacrylates and copolymers containing polyacrylate species, for example, polyacrylate salts (e.g., sodium and aluminum optionally with a Group II metal salt), sodium hexametaphosphates, non-ionic polyol, polyphosphoric acid, condensed sodium phosphate, non-ionic surfactants, alkanolamine, and other reagents commonly used for this function);
(f) antifoamers/defoamers, for example, in levels up to 1% by weight (e.g., blends of surfactants, tributyl phosphate, fatty polyoxyethylene esters plus fatty alcohols, fatty acid soaps, silicone emulsions and other silicone containing compositions, waxes and inorganic particulates in mineral oil, blends of emulsified hydrocarbons, and other compounds sold commercially to carry out this function);
(g) dry or wet pick improvement additives, for example, in levels up to 2% by weight (e.g., melamine resin, polyethylene emulsions, urea formaldehyde, melamine formaldehyde, polyimide, calcium stearate, styrene maleic anhydride, and others);
(h) dry or wet rub improvement and abrasion resistance additives, for example, in levels up to 2% by weight (e.g., glyoxal based resins, oxidized polyethylenes, melamine resins, urea formaldehyde, melamine formaldehyde, polyethylene wax calcium stearate, and others);
(i) gloss-ink hold-out additives, for example, in levels up to 2% by weight (e.g., oxidized polyethylenes, polyethylene emulsions, waxes, casein, guar gum, CMC, HMC, calcium stearate, ammonium stearate, sodium alginate, and others);
(j) dyes, for example, in levels up to 0.5% by weight;
(k) biocides/spoilage control agents, for example, in levels up to 1% by weight (e.g., metaborate, sodium dodecylbenene sulphonate, thiocyanate, organosulphur, sodium benzonate, and other compounds sold commercially for this function, for example, the range of biocide polymers sold by Calgon Corporation);
(l) levelling and evening aids, for example, in levels up to 2% by weight (e.g., non-ionic polyol, polyethylene emulsions, fatty acid, esters, and alcohol derivatives, alcohol/ethylene oxide, sodium CMC, HEC, alginates, calcium stearate, and other compounds sold commercially for this function);
(m) grease- and oil-resistance additives, for example, in levels up to 2% by weight (e.g., oxidized polyethylenes, latex, SMA (styrene maleic anhydride), polyamide, waxes, alginate, protein, CMC, and HMC);
(n) water-resistance additives, for example, in levels up to 2% by weight (e.g., oxidized polyethylenes, ketone resin, anionic latex, polyurethane, SMA, glyoxal, melamine resin, urea formaldehyde, melamine formaldehyde, polyamide, glyoxals, stearates, and other materials commercially available for this function); and
(o) insolubilizer, for example, in levels up to 2% by weight.

For all of the above-listed additives, the percentages by weight provided are based on the dry weight present in the composition. Aqueous bases having other compositions are contemplated.

According to some embodiments, a composition may include an aqueous base and a first optical brightener. The first optical brightener may include an alkaline earth metal compound and a fluorescence activator, wherein, for a given brightness of a product (e.g., a surface of a paper product) including the composition, the composition including the first optical brightener may include less of a second optical brightener different from the first optical brightener. For example, the second optical brightener may not include the fluorescence activator. According to some embodiments, the fluorescence activator may include least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium. According to some embodiments, the second optical brightener may be a traditional optical brightener (e.g., an organic brightening agent), which may include at least one of sulfonated triazole stilbenes, di-sulfonated stilbene biphenyl, coumarins, imidazolines, diazoles, triazoles, benzoxazolines, and biphenyl-stilbenes.

According to some embodiments, a method for reducing traditional optical brighteners (e.g., organic brightening agents) in a composition may include adding to the composition a first optical brightener. The first optical brightener may include at least one alkaline earth metal compound with a fluorescence activator. The method may further include adding to the composition less than or equal to about 1.5 wt % of a second optical brightener relative to the weight of the composition, wherein the second optical brightener does not include the fluorescence activator. For example, the fluorescence activator may include least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium. According to some embodiments, the alkaline earth metal may have a crystal structure, and the fluorescence activator may be contained in the crystal structure.

According to some embodiments of the method, the composition may include less than or equal to about 1.0 wt % of the second optical brightener relative to the weight of the composition. For example, the composition may include less than or equal to about 0.5 wt % the second optical brightener relative to the weight of the composition. According to some embodiments, the composition may not include any of the second optical brightener.

According to some embodiments of the method, the second optical brightener may be a traditional optical brightener. For example, the second optical brightener may include an organic brightening agent, which may include, for example, at least one of sulfonated triazole stilbenes, di-sulfonated stilbene biphenyl, coumarins, imidazolines, diazoles, triazoles, benzoxazolines, and biphenyl-stilbenes.

According to some embodiments of the method, the alkaline earth metal compound may be an alkaline earth metal carbonate. For example, the alkaline earth metal may include at least one of calcium carbonate, barium carbonate, and magnesium carbonate. According to some embodiments, the alkaline earth metal carbonate may include precipitated calcium carbonate, precipitated magnesium carbonate, co-precipitated calcium and magnesium carbonates, and mixtures thereof.

According to some embodiments of the method, the first optical brightener may comprise greater than or equal to about 1.0 wt % of the composition. For example, the first optical brightener may comprise greater than or equal to about 1.5 wt % of the composition. According to some embodiments of the method, the first optical brightener may be configured to emit fluorescent light, for example, when exposed to ultraviolet light.

According to some embodiments of the method, the composition may be configured as at least one of a coating composition, a paper making composition, and a sizing composition. For example, a product may include the composition. According to some embodiments, the product including the composition made by the method may have a brightness ranging from about 80 to about 100. For example, the product including the composition may have a brightness ranging from about 90 to about 100.

The optical brighteners disclosed herein may be obtained via a number of processes. For example, the optical brightener may include an alkaline earth metal carbonate doped with a fluorescence activator, such as, for example, precipitated calcium carbonate doped with a fluorescence activator, such as, for example, an impurity such as manganese. Such embodiments may be formed according to the following exemplary reaction:

CaCl₂—MnCl₂+(NH₄)₂CO₃→CaCO₃:Mn.

This exemplary process provides an optical brightener including a precipitated calcium carbonate doped with impurities such as manganese, and exhibits a generally rose to orange-red luminescence when irradiated. According to some embodiments of this process, additional inorganic fluorescence activators or impurities may be included, such as, for example, lead, thallium, and cerium salt. Other fluorescence activators are contemplated, such as, for example, least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium.

According to some embodiments, precipitated calcium carbonate may be obtained via another exemplary process. For example, a finely-divided phosphor grade calcium carbonate having a calcite crystalline structure and a very low sodium content may be formed from calcium chloride having a high sodium impurity content, such as, for example, 1.6% sodium chloride. The exemplary process may include forming finely-divided meta-stable vaterite on a continuous basis by continuously adding to an agitated precipitating tank aqueous solutions of calcium chloride and diammonium carbonate in such respective concentrations as to stoichiometrically produce calcium carbonate precipitate and ammonium chloride. The process may further include separating the resulting meta-stable vaterite precipitate from the mother liquor, and then resuspending the separated vaterite in an aqueous medium. Thereafter, the process may include heating the resuspended vaterite to a temperature of at least 80° C. for a sufficient period of time to cause the crystal structure of the vaterite to substantially or completely convert to calcite. The process may also include recovering the resulting calcite, which may have a sodium impurity content in the range of from about 10 parts per million (ppm) to 35 ppm. The impurities such as the fluorescence activators mentioned herein, and others, may be incorporated into the calcite crystalline structure during the reactions and/or following the reactions (e.g., in the form of a coating on the calcite crystalline structure).

According to another exemplary process, precipitated calcium carbonate may be obtained via another process that forms calcium carbonate and ammonium sulfate from gypsum (e.g., gypsum obtained from flue gas desulfurization (FGD), which may be present at electric power plants). According to this exemplary process, FGD gypsum may be obtained from sulfur dioxide SO₂ gas emission control systems used at fossil fuel combustion power plants (e.g., coal-fired power plants) to remove sulfur from the combustion gases using “scrubber” devices. The sulfur dioxide may be derived from any sulfur containing compounds in the fuels. A scrubber uses lime (calcium oxide or calcium hydroxide) or more typically, limestone (calcium carbonate) to react with sulfur dioxide gas to remove the sulfur in a solid form. The scrubbing reaction uses a limestone (CaCO₃)-water slurry to produce calcium sulfite (CaSO₃) according to the following exemplary reaction:

CaCO₃ (solid)+SO₂ (gas)→CaSO₃ (solid)+CO₂ (gas).

Thereafter, the CaSO₃ (calcium sulfite) may be further oxidized to produce CaSO₄.2H₂O (FGD gypsum) according to the following exemplary reaction:

CaSO₃ (solid)+H₂O (liquid)+½ O₂ (gas)→CaSO₄ (solid)+H₂O Hydration CaSO₄.½H₂O+1½ H₂O CaSO₄.2H₂O.

Thereafter, the exemplary process may further include a chemical reaction of FGD gypsum (CaSO₄.2H₂O) with ammonium carbonate ((NH₄)₂CO₃) to produce ammonium sulfate ((NH₄)₂SO₄) and calcium carbonate (CaCO₃) according to the following exemplary reaction:

(NH₄)₂CO₃+CaSO₄.2H₂O→(NH₄)₂SO₄+CaCO₃+2H₂O.

The impurities such as the fluorescence activators mentioned herein, and others, may be incorporated into the resulting precipitated calcium carbonate structure during the reactions and/or following the reactions (e.g., in the form of a coating on the calcium carbonate).

In one embodiment, a traditional process for making PCC (i.e., the lime cycle) may be used. In this process, the fluorescence activator, which may be in the form of a water soluble or water reactive salt, is added to the hydrated lime slurry obtained from the slaking process.

Other processes for forming optical brighteners including alkaline earth metal are contemplated.

Other embodiments of the invention will be apparent to those skilled in the art from consideration of the specification and practice of the exemplary embodiments disclosed herein. It is intended that the specification and examples be considered as exemplary only, with a true scope and spirit of the invention being indicated by the following claims.

1. A composition comprising:
a base material comprising at least one optical brightener, said optical brightener comprising an alkaline earth compound doped with an inorganic fluorescence activator, wherein the composition is configured as at least one of a coating composition, a paper making composition, an ink composition, and a sizing composition.

2. The composition of claim 1, wherein the fluorescence activator comprises at least one mixture, compound, element or alloy of manganese, molybdenum, copper, uranium, cesium, thorium, lead, cobalt, iron, strontium, calcium, magnesium, barium, fin, yttrium, thallium, samarium, cerium, thulium, and dysprosium.

3. The composition of claim 1, wherein the base material comprises a resin, a fusible powder, an aqueous composition, or a solvent composition.

4. The composition of claim 1, wherein the alkaline earth compound comprises an alkaline earth metal or alkaline earth salt.

5. The composition of claim 4, wherein the alkaline earth metal salt is an alkaline earth metal carbonate.

6. The composition of claim 5, wherein the alkaline earth carbonate comprises at least one of calcium carbonate, barium carbonate, and magnesium carbonate.

7. The composition of claim 6, wherein said calcium carbonate comprises precipitated calcium carbonate.

8. The composition of claim 1, wherein the alkaline earth compound comprises a mixture of calcium and magnesium carbonates.

9. The composition of claim 8, wherein said mixture comprises co-precipitated calcium and magnesium carbonates.

10. The composition of claim 1, wherein the alkaline earth compound has a crystal structure, and wherein the inorganic fluorescence activator is contained in the crystal structure.

11. The composition of claim 1, wherein the optical brightener comprises greater than or equal to about 1.0 wt % of the composition.

12. The composition of claim 1, wherein the optical brightener comprises greater than or equal to about 1.5 wt % of the composition.

13. The composition of claim 1, wherein the optical brightener is configured to emit fluorescent light.

14. A product comprising the composition of claim 1.

15. The product of claim 14, wherein the product has a brightness ranging from about 80 to about 100.

16-32. (canceled)

33. The composition of claim 1, wherein the base is an aqueous base.

34-43. (canceled)

44. The composition of claim 1, wherein
the base is an aqueous base,
the optical brightener is comprising a first optical brightener,
wherein for a given brightness of a product including the composition, the composition comprising the first optical brightener comprises less of a second optical brightener different from the first optical brightener.

45-58. (canceled)

59. A method for reducing traditional optical brighteners in a composition, the method comprising;
adding to the composition a base material comprising at least a first optical brightener comprising:
at least one an alkaline earth compound doped with an inorganic fluorescence activator; and
adding to the composition less than or equal to about 1.5 wt % of a second optical brightener relative to the weight of the composition, wherein the second optical brightener does not include the fluorescence activato
